(19) United States
(12) Patent Application Publication
(10) Pub. No.: US 2026/0367313 A1
(43) Pub. Date: Nov. 19, 2026

(54) INTEGRATED PHOTONIC CHIP, ARRAY AND CUTTING METHOD THEREOF

(71) Applicant: SILITH TECHNOLOGY (SUZHOU) CO., LTD., Shanghai (CN)

(72) Inventors: Xingyu ZHANG, Shanghai (CN); Ke ZHANG, Shanghai (CN)

(21) Appl. No.: 19/486,968

(22) PCT Filed: May 24, 2023
(86) PCT No.: PCT/CN2023/096006

§ 371 Date: Nov. 24, 2025

(51) Int. Cl. G02B 6/12; G02B 6/125; G02B 6/13

(52) U.S. Cl. CPC G02B 6/12007; G02B 6/125; G02B 6/13; G02B 2006/121; G02B 2006/1215; G02B 2006/12164

(57) ABSTRACT

Provided herein are an integrated photonic chip, an array and a cutting method thereof. The chip includes a function block, an optical input unit provided with N cascaded layers, an optical output unit provided with M cascaded layers, a plurality of optical input transmission channels, a plurality of optical output transmission channels and to-be-cut lines. The optical input unit provided with the N cascaded layers includes an nth optical input sub-unit connected with optical input ports of the function block by the optical input transmission channels, and a first optical input sub-unit. The optical output unit provided with the M cascaded layers includes an mth optical output sub-unit connected with optical input ports of the function block by the optical output transmission channels, and a first optical output sub-unit. The chip is configured to be selectively cut to form a first integrated photonic device and a second integrated photonic device different from the first integrated photonic device.

### TECHNICAL FIELD

The present invention relates to the field of integrated photonic chips, in particular to an integrated photonic chip, an array and a cutting method thereof.

### BACKGROUND

At present, multi-channel photonic integrated circuits are widely used in various optical applications such as sensing, communication, and computing. These channels may carry optical signals of the same wavelength split from a shared optical source or may carry optical information of different wavelengths from multiple optical sources. In a conventional multi-channel photonic integrated circuit design, the number of required optical input and output ports is fixed. To match with different numbers of optical input and output ports required by integrated photonic devices, different layouts are needed, which is low in efficiency.

Therefore, there is an urgent need for a new type of integrated photonic chip, an array and a cutting method thereof to improve the above problems.

### SUMMARY

The present invention aims to provide an integrated photonic chip, an array and a cutting method thereof. The chip is configured to be cut to form different integrated photonic devices.

In a first aspect, the present invention provides an integrated photonic chip configured for combining or splitting the optical signals, the chip comprises an optical waveguide configured for transmitting optical signals by the optical waveguide. The integrated photonic chip comprises a function block, an optical input unit provided with N cascaded layers, an optical output unit provided with M cascaded layers, a plurality of optical input transmission channels, a plurality of optical output transmission channels and to-be-cut lines.

The optical input unit provided with the N cascaded layers comprises an nth optical input sub-unit connected with optical input ports of the function block by the optical input transmission channels, and a first optical input sub-unit, n being an integer greater than or equal to two.

The optical output unit provided with the M cascaded layers includes an mth optical output sub-unit connected with optical input ports of the function block by the optical output transmission channels, and a first optical output sub-unit, m being an integer greater than or equal to two.

The integrate photonic chip can be cut to selectively form a first integrated photonic device and a second integrated photonic device different from the first integrated photonic device by the to-be-cut line or lines formed on a predetermined cascaded layer of the optical input unit and/or the optical output unit.

The method of the present invention has the beneficial effects that the same integrated photonic chip can be cut to selectively form a first integrated photonic device and a second integrated photonic device by the to-be-cut line or lines formed on a predetermined cascaded layer of the optical input unit and/or the optical output unit, and the production efficiency is enhanced; and by cutting the chip along different to-be-cut lines, a first integrated photonic device and a second integrated photonic device which has numbers of optical input ports and numbers of optical output ports different from those of the first integrated photonic device can be selectively and flexibly obtained.

Optionally, the optical input unit adopts cascaded demultiplexers or splitters, and the optical output unit adopts cascaded multiplexers or combiners.

Optionally, when the optical input unit adopts the cascaded demultiplexers, the first input sub-unit is provided with one input port and the nth input sub-unit is provided with n input ports; and when the optical output unit adopts the cascaded multiplexers, the first output sub-unit is provided with one output port and the mth optical output sub-unit is provided with m output ports.

Optionally, when the optical input unit adopts the cascaded splitters, the first input sub-unit is provided with one input port and the nth input sub-unit is provided with n input ports; and when the optical output unit adopts the cascaded combiners, the first output sub-unit is provided with one output port and the mth output sub-unit is provided with m output ports.

Optionally, when the optical input unit adopts the cascaded splitters, the first input sub-unit is provided with one input port and the nth input sub-unit is provided with n input ports; and when the optical output unit adopts the cascaded multiplexers, the first output sub-unit is provided with one output port and the mth output sub-unit is provided with m output ports.

Optionally, the first integrated photonic device is provided with one optical input port and m optical output ports, and the second integrated photonic device is provided with n optical input ports and one optical output port.

Optionally, the first integrated photonic device is provided with two optical input ports and m optical output ports, and the second integrated photonic device is provided with n optical input ports and two optical output ports.

Optionally, the optical input unit and the optical output unit are located at opposite sides or a same side of the chip.

Optionally, the function block, the optical input unit and the optical output unit are all arranged on a common chip; and a material of a substrate layer of the chip is made of at least one material selected from bulk silicon, silicon-on-insulator, silicon-on-sapphire, silicon dioxide, indium phosphide, lithium niobate, aluminum oxide and polymer.

Optionally, the optical waveguide comprises at least one selected from a channel waveguide, a ridge waveguide, a groove waveguide, a diffused waveguide, and a photonic crystal waveguide.

Optionally, a wavelength range of the optical signal comprises at least one selected from a visible light band, an O band, an E band, an S band, a C band, an L band, a U band, and a mid-infrared band.

In a second aspect, the present invention provides an integrated photonic chip array, including a plurality of chips distributed in rows and columns.

In a row direction of the array, a first chip is arranged adjacent to a second chip, and an optical output port of the first chip is connected with an optical input port of the second chip.

In a column direction of the array, a to-be-cut line of the first chip is collinear with that of a third chip.

In a third aspect, the present invention provides a cutting method for an integrated photonic chip, including cutting the integrated photonic chip. The same integrated photonic chip can be cut to selectively form a first integrated photonic device and a second integrated photonic device different from the first integrated photonic device by to-be-cut line or lines of the integrated photonic chip.

In a fourth aspect, the present invention provides an integrated photonic chip. The integrated photonic chip includes a function block, an optical input unit, an optical output unit, a plurality of optical input transmission channels, and a plurality of optical output transmission channels. The optical input unit is provided with N cascaded layers; or the optical output unit is provided with M cascaded layers.

The optical input unit provided with the N cascaded layers includes an nth optical input sub-unit connected with optical input ports of the function block by the optical input transmission channels, and a first optical input sub-unit, the first input sub-unit is provided with one input port, and the nth input sub-unit is provided with n input ports, n being an integer greater than or equal to two.

The optical output unit provided with the M cascaded layers includes an mth optical output sub-unit connected with optical output ports of the function block by the optical output transmission channels, and a first optical output sub-unit, the first output sub-unit is provided with one output port, and the mth output sub-unit is provided with m output ports, m being an integer greater than or equal to two.

Optionally, the optical input unit adopts cascaded demultiplexers or splitters, and the optical output unit adopts cascaded multiplexers or combiners.

### BRIEF DESCRIPTION OF THE DRAWINGS

FIG. 1 is a schematic structural diagram of an integrated photonic chip provided with demultiplexers and multiplexers according to the present invention;

FIG. 2 is a schematic structural diagram of an integrated photonic chip provided with splitters and combiners according to the present invention;

FIG. 3 is a schematic structural diagram of an integrated photonic chip provided with splitters and multiplexers according to the present invention;

FIG. 4 is a schematic structural diagram of an integrated photonic chip array according to the present invention.

### DETAILED DESCRIPTION

In order to make objectives, technical solutions and advantages of the present invention clearer, the technical solutions in embodiments of the present invention will be clearly and completely described below in conjunction with the drawings of the present invention. Obviously, the described embodiments are part of, but not all of, the embodiments of the present invention. Based on the embodiments of the present invention, all other embodiments obtained by those of ordinary skill in the art without creative work are included in the protection scope of the present invention. Unless otherwise defined, technical or scientific terms used herein should have the meanings usually understood by those of ordinary skill in the field to which the present invention belongs. As used herein, terms such as “include” mean that an element or item appearing before the term encompasses elements or items appearing after the term and their equivalents, but does not exclude other elements or items.

The present invention provides an integrated photonic chip configured for combining or splitting the optical signals, the chip comprising an optical waveguide and transmitting optical signals by the optical waveguide and. The integrated photonic chip comprises a function block, an optical input unit provided with N cascaded layers, an optical output unit provided with M cascaded layers, a plurality of optical input transmission channels, a plurality of optical output transmission channels and to-be-cut lines.

The optical input unit provided with the N cascaded layers includes an nth optical input sub-unit connected with optical input ports of the function block by the optical input transmission channels, and a first optical input sub-unit, n being an integer greater than or equal to two.

The optical output unit provided with the M cascaded layers includes an mth optical output sub-unit connected with optical input ports of the function block by the optical output transmission channels, and a first optical output sub-unit, m being an integer greater than or equal to two.

The integrate photonic chip can be selectively cut to form a first integrated photonic device and a second integrated photonic device different from the first integrated photonic device by the to-be-cut line or lines formed on a predetermined cascaded layer of the optical input unit and/or the optical output unit.

It should be noted that the to-be-cut line or lines in the present invention may be visible or invisible imaginary, which is not limited herein.

The integrated photonic chip can be cut to selectively form a first integrated photonic device and a second integrated photonic device, different from the first integrated photonic device by the to-be-cut line or lines formed on the predetermined cascaded layer of the optical input unit and/or the optical output unit, and the production efficiency is enhanced; and by cutting the chip along different to-be-cut lines, a first integrated photonic device and a second integrated photonic device which has numbers of optical input ports and numbers of optical output ports different from those of the first integrated photonic device can be selectively and flexibly obtained.

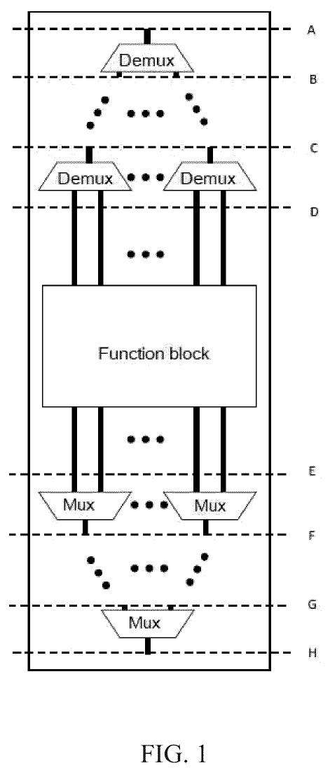

As shown in FIG. 1, the present embodiment provides an integrated photonic chip. When the optical input unit adopts the cascaded demultiplexers, the first input sub-unit is provided with one input port, and the nth input sub-unit is provided with n input ports (not labeled, close to a to-be-cut line C); and when the optical output unit adopts the cascaded multiplexers, the first output sub-unit is provided with one output port, and the mth optical output sub-unit is provided with m output ports (not labeled, close to a to-be-cut line F).

Specifically, the center of the chip is provided with a function block, one side of the function block is provided with an optical input unit having N cascaded demultiplexers, and the other side of the function block is provided with an optical output unit having M cascaded multiplexers, both M and N being integers greater than or equal to two. The first cascaded layer of the optical input unit is the first input sub-unit, and the first input sub-unit is provided with one demux and is arranged at the first edge of the chip; and the Nth cascaded layer of the optical input unit is an nth input sub-unit, and the nth input sub-unit is provided with n demultiplexers and is adjacent to the function block. In one embodiment of the present invention, each demux is provided with one input port, and n demultiplexers are provided with n input ports (not labeled, close to the to-be-cut line C), n being an integer greater than or equal to two. The first cascaded layer of the optical output unit is the first output sub-unit, and the first output sub-unit is provided with one mux and is arranged at the second edge of the chip; and the Mth cascaded layer of the optical output unit is the mth optical output sub-unit, and the mth optical output sub-unit is provided with m multiplexers and is adjacent to the function block, m being an integer greater than or equal to two. In one embodiment of the present invention, each mux is provided with one output port, and m multiplexers are provided with m output ports (not labeled, close to the to-be-cut line F).

Exemplarily, the optical waveguide includes at least one selected from a channel waveguide, a ridge waveguide, a groove waveguide, a diffused waveguide, and a photonic crystal waveguide. The wavelength range of the optical signal includes at least one selected from a visible light band, an O band, an E band, an S band, a C band, an L band, a U band, and a mid-infrared band. The function block, the optical input unit and the optical output unit are all arranged on the same chip; and a substrate layer of the chip is made of at least one material selected from bulk silicon, silicon-on-insulator, silicon-on-sapphire, silicon dioxide, indium phosphide, lithium niobate, aluminum oxide and polymer.

Each demux shown in FIG. 1 is provided with one input port (not labeled, close to a to-be-cut line A) at one end and two output ports (not labeled, close to a to-be-cut line B) at the other end. In other embodiments, the number of input ports of the demux may be greater than two, such as three, or four, which is not limited herein. Similarly, the number of output ports of the demux may be greater than two, such as three, or four, which is not limited herein. Both n and m may be odd or even, depending on the number of optical input ports and the number of optical output ports required in different applications.

The optical input ports and the optical output ports shown in FIG. 1 are drawn at opposite sides of the chip. It should be understood that in other examples, the optical input ports and the optical output ports may further be arranged at the same side. For example, an output waveguide may be bent and routed so that the optical input port and the optical output port may be aligned at the same edge of the chip. The application scenarios of the present embodiment include, but are not limited to, optical sensing, beam control, optical interconnection, and optical computing.

It is worth noting that in the present embodiment, the demux is configured to split optical signals of different wavelengths, and the mux is configured to combine optical signals of different wavelengths. Both sides of each cascaded layer of the optical input unit and the optical output unit are provided with to-be-cut lines, and optical signals can be coupled in and out of the waveguide by cutting edges of the chip.

As shown in FIG. 1, in one embodiment of the present invention, when the optical input unit adopts the cascaded demultiplexers, an area between the to-be-cut lines C and D is defined as an nth input sub-unit, and an area between the to-be-cut lines A and B is defined as the first input sub-unit. The nth input sub-unit is provided with n demultiplexers, and the first input sub-unit is provided with one demux. In one embodiment of the present invention, each demux is provided with one input port (not labeled, close to the to-be-cut line A), the nth input sub-unit is provided with n demultiplexers, the n demultiplexers are provided with n input ports (not labeled, close to the to-be-cut line C), n being an integer greater than or equal to two.

When the optical output unit adopts the cascaded multiplexers, an area between to-be-cut lines E and F is defined as an mth optical output sub-unit, and an area between to-be-cut lines G and H is defined as the first optical output sub-unit; and the mth optical output sub-unit is provided with m multiplexers, and the first input sub-unit is provided with one mux. In one embodiment of the present invention, each mux is provided with one output port (not labeled, close to the to-be-cut line H), the mth optical output sub-unit is provided with m multiplexers, the m multiplexers are provided with m output ports (not labeled, close to the to-be-cut line F), m being an integer greater than or equal to two.

Exemplarily, an integrated photonic device with one input port and m output ports can be obtained by cutting the chip along the to-be-cut lines A and F. In other examples, an integrated photonic device with two input ports and m output ports can be obtained by cutting the chip along the to-be-cut lines B and F. It should be understood that in still other examples, the chip may be cut along the to-be-cut lines of the optical input unit, leaving the optical output unit intact, or the chip may be cut along the to-be-cut lines of the optical output unit, leaving the optical input unit intact.

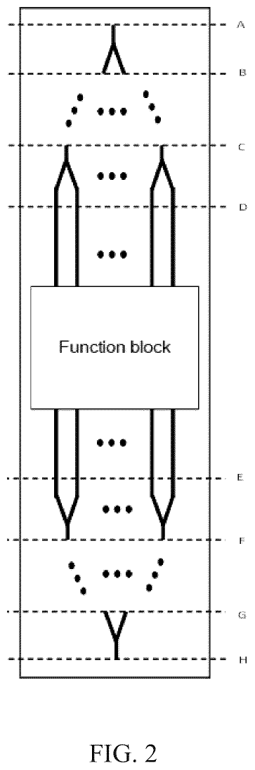

As shown in FIG. 2, the present embodiment provides another integrated photonic chip. When the optical input unit adopts the cascaded splitter, the first input sub-unit is provided with one input port (not labeled, close to the to-be-cut line A), and the nth input sub-unit is provided with n input ports (not labeled, close to the to-be-cut line C); and when the optical output unit adopts the cascaded combiners, the first output sub-unit is provided with one output port (not labeled, close to the to-be-cut line H), and the mth optical output sub-unit is provided with m output ports (not labeled, close to the to-be-cut line F).

Specifically, one side of the function block is provided with the optical input unit having the N cascaded splitters; and the other side of the function block is provided with the optical output unit having the M cascaded combiners. The first cascaded layer of the optical input unit is provided with one splitter and is arranged at the first edge of the chip; and the Nth cascaded layer of the optical input unit is provided with n splitters, and is adjacent to the function block. In one embodiment of the present invention, each splitter is provided with one input end (not labeled, close to the to-be-cut line A), and n splitters are provided with n input ends (not labeled, close to the to-be-cut line C). The first cascaded layer of the optical output unit is provided with one combiner and is arranged at the second edge of the chip; and the Mth cascaded layer of the optical output unit is provided with m combiners and is adjacent to the function block. In one embodiment of the present invention, each combiner is provided with one output end (not labeled, close to the to-be-cut line H), and m combiners are provided with m output ends (not labeled, close to the to-be-cut line F). In other examples, the number of input ports of the splitter may be greater than two, such as three, or four, which is not limited herein. Similarly, the number of output ports of the combiner may be greater than two, such as three, or four, which is not limited herein. Both n and m may be odd or even, depending on the number of optical input ports and the number of optical output ports required in different applications. It is worth noting that in the present embodiment, the splitter is configured to split optical signals of the same wavelength, and the combiner is configured to combine optical signals of the same wavelength.

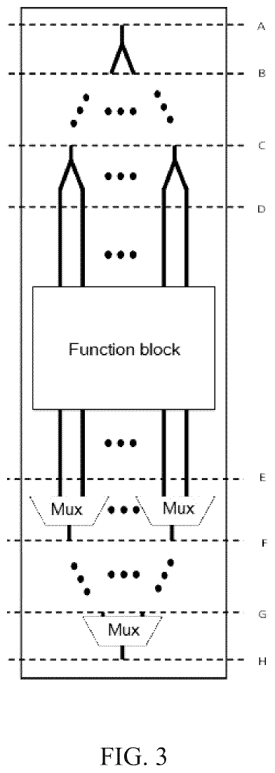

As shown in FIG. 3, the present embodiment provides still another integrated photonic chip. When the optical input unit adopts the cascaded splitter, the first input sub-unit is provided with one input port (not labeled, close to the to-be-cut line A), and the nth input sub-unit is provided with n input ports (not labeled, close to the to-be-cut line C); and when the optical output unit adopts the cascaded multiplexers, the first output sub-unit is provided with one output port (not labeled, close to the to-be-cut line H), and the mth output sub-unit is provided with m output ports (not labeled, close to the to-be-cut line F).

Specifically, one side of the function block is provided with the optical input unit provided with the N cascaded splitters; and the other side of the function block is provided with the optical output unit provided with the M cascaded multiplexers. The first cascaded layer of the optical input unit is provided with one splitter and is arranged at the first edge of the chip; the Nth cascaded layer of the optical input unit is provided with n splitters and is adjacent to the function block; each splitter is provided with one input port (not labeled, close to the to-be-cut line A), and n splitters are provided with n input ports (not labeled, close to the to-be-cut line C). The first cascaded layer of the optical output unit is provided with one mux and is arranged at the second edge of the chip; and the Mth cascaded layer of the optical output unit is provided with m multiplexers and is adjacent to the function block. Each mux is provided with one output port (not labeled, close to the to-be-cut line H), and n multiplexers are provided with n output ports (not labeled, close to the to-be-cut line F). In other examples, the number of input ports of the splitter may be greater than two, such as three, or four, which is not limited herein. Similarly, the number of output ports of the mux may further be greater than two, such as three, or four, which is not limited herein. Both n and m may be odd or even, depending on the number of optical input ports and the number of optical output ports required in different applications. It is worth noting that in the present embodiment, the splitter is configured to split optical signals of the same wavelength, and the mux is configured to combine optical signals of the same wavelength.

In still other possible embodiments, one side of the function block is provided with the optical input unit having the N cascaded demultiplexers; and the other side of the function block is provided with the optical output unit having the M cascaded combiners. The first cascaded layer of the optical input unit is provided with one demux and is arranged at the first edge of the chip; the Nth cascaded layer of the optical input unit is provided with n demultiplexers and is adjacent to the function block; and each demux is provided with one input port, and n demultiplexers are provided with n input ports. The first cascaded layer of the optical output unit is provided with one combiner and is arranged at the second edge of the chip; the Mth cascaded layer of the optical output unit is provided with m combiners and is adjacent to the function block; and each combiner is provided with one output port, and n combiners are provided with n output ports. In other examples, the number of input ports of the demux may be greater than two, such as three, or four, which is not limited herein. Similarly, the number of output ports of the combiner may be greater than two, such as three, or four, which is not limited herein. Both n and m may be odd or even, depending on the number of optical input ports and the number of optical output ports required in different applications. It is worth noting that in the present embodiment, the demux is configured to split optical signals of the same wavelength, and the combiner is configured to combine optical signals of the same wavelength.

The integrated photonic chip can be selectively cut to form a first integrated photonic device and a second integrated photonic device, different from the first integrated photonic device, by the to-be-cut lines selectively formed on a predetermined cascaded layer of the optical input unit and/or the optical output unit, and the production efficiency is enhanced; and by cutting the chip along different to-be-cut lines, a first integrated photonic device and a second integrated photonic device with different numbers of optical input ports and different numbers of optical output ports can be selectively and flexibly obtained. In some embodiments of the present invention, the first integrated photonic device is provided with one optical input port and m optical output ports, and the second integrated photonic device is provided with n optical input ports and one optical output port.

In other embodiments of the present invention, the first integrated photonic device is provided with two optical input ports and m optical output ports, and the second integrated photonic device is provided with n optical input ports and two optical output ports.

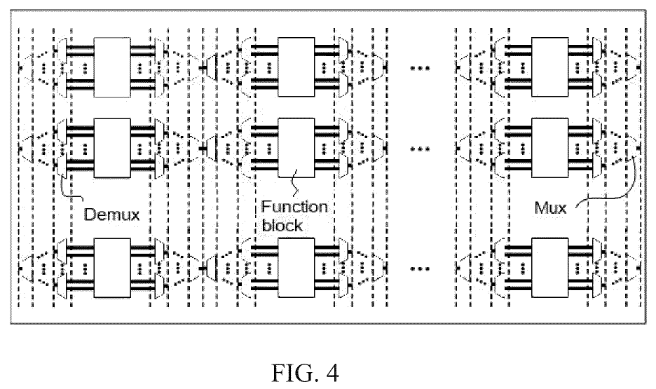

As shown in FIG. 4, the present application further provides an integrated photonic chip array, including a plurality of integrated photonic chips as shown in FIG. 1, FIG. 2 or FIG. 3 distributed in rows and columns.

In a row direction of the array, a first chip is arranged adjacent to a second chip, and an optical output port of the first chip is connected with an optical input port of the second chip.

In a column direction of the array, a to-be-cut line of the first chip is collinear with that of a third chip.

Specifically, in the row direction of the array, a (P−1)th chip is arranged adjacent to a Pth chip, and an optical output port of the (P−1)th chip is connected with an optical input port of the Pth chip, thereby facilitating co-test of multiple chips. In the column direction of the array, chips of each column share to-be-cut lines, an Lth to-be-cut line of a (Q−1)th chip is collinear with an Lth to-be-cut line of a Qth chip, P, Q, and L are arbitrary positive integers, and P and Q are greater than one.

The present application further provides a cutting method for an integrated photonic chip, including cutting the integrated photonic chip in the above embodiment. The same integrated photonic chip can be selectively cut to form a first integrated photonic device and a second integrated photonic device, different from the first integrated photonic device, by to-be-cut line or lines of the integrated photonic chip.

The present application further provides an integrated photonic chip. The integrated photonic chip includes a function block, an optical input unit, an optical output unit, a plurality of optical input transmission channels, and a plurality of optical output transmission channels. The optical input unit is provided with N cascaded layers; or the optical output unit is provided with M cascaded layers.

The optical input unit provided with the N cascaded layers includes an nth optical input sub-unit connected with optical input ports of the function block by the optical input transmission channels, and a first optical input sub-unit, the first input sub-unit is provided with one input port, and the nth input sub-unit is provided with n input ports, n being an integer greater than or equal to two.

The optical output unit provided with the M cascaded layers includes an mth optical output sub-unit connected with optical output ports of the function block by the optical output transmission channels, and a first optical output sub-unit, the first output sub-unit is provided with one output port, and the mth output sub-unit is provided with m output ports, m being an integer greater than or equal to two.

Optionally, the optical input unit adopts cascaded demultiplexers or splitters, and the optical output unit adopts cascaded multiplexers or combiners.

While the embodiments of the present invention have been described in detail above, it will be apparent to those skilled in the art that various modifications and variations can be made to the embodiments. It is to be understood, however, that such modifications and variations are within the scope and spirit of the present invention as set forth in the claims. Moreover, the present invention described herein is capable of other embodiments and of being practiced or of being carried out in various ways.

1. An integrated photonic chip for combining or splitting the optical signals, the chip comprises an optical waveguide configured for transmitting optical signals by the optical waveguide, wherein the integrated photonic chip comprises a function block, an optical input unit provided with N cascaded layers, an optical output unit provided with M cascaded layers, a plurality of optical input transmission channels, a plurality of optical output transmission channels and to-be-cut lines;
the optical input unit provided with the N cascaded layers comprises an nth optical input sub-unit connected with optical input ports of the function block by the optical input transmission channels, and a first optical input sub-unit, n being an integer greater than or equal to two;
the optical output unit provided with the M cascaded layers comprises an mth optical output sub-unit connected with optical input ports of the function block by the optical output transmission channels, and a first optical output sub-unit, m being an integer greater than or equal to two; and
the integrate photonic chip can be selectively cut to form a first integrated photonic device and a second integrated photonic device different from the first integrated photonic device by the to-be-cut line or lines formed on a predetermined cascaded layer of the optical input unit and/or the optical output unit.

2. The integrated photonic chip according to claim 1, wherein the optical input unit adopts cascaded demultiplexers or splitters, and the optical output unit adopts cascaded multiplexers or combiners.

3. The integrated photonic chip according to claim 2, wherein, when the optical input unit adopts the cascaded demultiplexers, the first input sub-unit is provided with one input port and the nth input sub-unit is provided with n input ports; and when the optical output unit adopts the cascaded multiplexers, the first output sub-unit is provided with one output port and the mth optical output sub-unit is provided with m output ports.

4. The integrated photonic chip according to claim 2, wherein, when the optical input unit adopts the cascaded splitters, the first input sub-unit is provided with one input port and the nth input sub-unit is provided with n input ports; and when the optical output unit adopts the cascaded combiners, the first output sub-unit is provided with one output port and the mth output sub-unit is provided with m output ports.

5. The integrated photonic chip according to claim 2, wherein, when the optical input unit adopts the cascaded splitters, the first input sub-unit is provided with one input port and the nth input sub-unit is provided with n input ports; and when the optical output unit adopts the cascaded multiplexers, the first output sub-unit is provided with one output port and the mth output sub-unit is provided with m output ports.

6. The integrated photonic chip according to claim 1, wherein the first integrated photonic device is provided with one optical input port and m optical output ports, and the second integrated photonic device is provided with n optical input ports and one optical output port.

7. The integrated photonic chip according to claim 1, wherein the first integrated photonic device is provided with two optical input ports and m optical output ports, and the second integrated photonic device is provided with n optical input ports and two optical output ports.

8. The integrated photonic chip according to claim 2, wherein the optical input unit and the optical output unit are located at opposite sides or a same side of the chip.

9. The integrated photonic chip according to claim 2, wherein the function block, the optical input unit and the optical output unit are all arranged on a common chip; and
a substrate layer of the chip is made of at least one material selected from bulk silicon, silicon-on-insulator, silicon-on-sapphire, silicon dioxide, indium phosphide, lithium niobate, aluminum oxide and polymer.

10. The integrated photonic chip according to claim 1, wherein the optical waveguide comprises at least one selected from a channel waveguide, a ridge waveguide, a groove waveguide, a diffused waveguide, and a photonic crystal waveguide.

11. The integrated photonic chip according to claim 1, wherein a wavelength range of the optical signal comprises at least one selected from a visible light band, an O band, an E band, an S band, a C band, an L band, a U band, and a mid-infrared band.

12. An integrated photonic chip array, comprising a plurality of the chips of claim 1 distributed in rows and columns, wherein
in a row direction of the array, a first chip is arranged adjacent to a second chip, and an optical output port of the first chip is connected with an optical input port of the second chip; and
in a column direction of the array, a to-be-cut line of the first chip is collinear with that of a third chip.

13. A cutting method for an integrated photonic chip, comprising cutting the chip of claim 1, wherein the same integrated photonic chip can be selectively cut to form a different first integrated photonic device and a second integrated photonic device different from the first integrated photonic device by to-be-cut line or lines of the integrated photonic chip.

14. An integrated photonic device, comprising a function block, an optical input unit, an optical output unit, a plurality of optical input transmission channels, and a plurality of optical output transmission channels, wherein the optical input unit is provided with N cascaded layers; or the optical output unit is provided with M cascaded layers;
the optical input unit provided with the N cascaded layers comprises an nth optical input sub-unit connected with optical input ports of the function block by the optical input transmission channels, and a first optical input sub-unit, the first input sub-unit is provided with one input port, and the nth input sub-unit is provided with n input ports, n being an integer greater than or equal to two; and
the optical output unit provided with the M cascaded layers comprises an mth optical output sub-unit connected with optical output ports of the function block by the optical output transmission channels, and a first optical output sub-unit, the first output sub-unit is provided with one output port, and the mth output sub-unit is provided with m output ports, m being an integer greater than or equal to two.

15. The integrated photonic device of claim 14, wherein the optical input unit adopts cascaded demultiplexers or splitters, and the optical output unit adopts cascaded multiplexers or combiners.
